(19) United States
(12) Patent Application Publication
(10) Pub. No.: US 2026/0172117 A1
(43) Pub. Date: Jun. 18, 2026

(54) TRANSMITTER, RECEIVER, AND CONTROL METHOD

(71) Applicant: NTT, Inc., Tokyo (JP)

(72) Inventors: Ryo KOMA, Musashino-shi (JP); Junichi KANI, Musashino-shi (JP); Kazutaka HARA, Musashino-shi (JP); Ryo IGARASHI, Musashino-shi (JP)

(73) Assignee: NTT, Inc., Tokyo (JP)

(21) Appl. No.: 18/721,336

(22) PCT Filed: Dec. 21, 2021
(86) PCT No.: PCT/JP2021/047161

§ 371 Date: Jun. 18, 2024

(51) Int. Cl. H04B 10/516; H04B 10/40; H04B 10/60

(52) U.S. Cl. CPC H04B 10/5161; H04B 10/40; H04B 10/60

(57) ABSTRACT

According to an embodiment of the present invention, a transmission device includes: a first modulation unit configured to perform intensity modulation on a control signal for performing management control of communication; a second modulation unit configured to perform phase modulation or frequency modulation on the control signal; a reception modulation scheme acquisition unit configured to acquire a modulation scheme receivable by a receiver receiving the control signal; and a modulation control unit configured to cause the first or second modulation unit to modulate the control signal in accordance with a modulation scheme acquired by the reception modulation scheme acquisition unit.

### TECHNICAL FIELD

The present invention relates to a technique for a transmitter, a receiver, and a control method.

### BACKGROUND ART

There is an innovative optical and wireless network (IOWN) which minimizes photoelectric conversion and electric routing processing as much as possible. FIG. 30 is a diagram illustrating a configuration of an IOWN. A user device in an all-photonics network (APN) of the IOWN illustrated in FIG. 30 communicates using a wavelength and a route allocated to an APN controller connected to a Ph-GW.

Exchange of information regarding a wavelength or a route is performed using a control signal channel called an auxiliary management and control channel (AMCC) when communication of a user device starts. When the communication starts, an AMCC transceiver disposed in the Ph-GW communicates with the user device and is connected to any communication destination.

The AMCC may be used not only for communication with a nearest Ph-GW but also for exchange of a control signal between AMCC-compatible user devices. The AMCC between AMCC-compatible user devices is likely to be used to transmit and receive control signals such as NW control information and a configuration of communication wavelengths. Further, the AMCC is likely to be used to transmit and receive control information to and from a device that provides a service to the user device.

As illustrated in FIG. 31, a currently assumed user device is considered to have a configuration in which the light emitted from a light source is modulated using a signal obtained by superimposing a user signal DATA and an AMCC signal DATA_AMCC by an intensity modulator such as an EA modulator (see NON PATENT LITERATURE 1). At this time, a frequency of an AMCC signal is superimposed on a frequency bandwidth that has a slight influence on a user signal.

For example, as illustrated in FIG. 32, the AMCC signal is superimposed on a low frequency side. In the configuration illustrated in FIG. 31, since the AMCC signal is superimposed by intensity modulation, the AMCC signal can be demodulated by using a simple optical receiver on a receiver side of the Ph-GW or the user device. On the other hand, when a simple receiver is interrupted on a communication route, the AMCC signal flowing on the route can be easily acquired in that intensity modulation is used.

FIGS. 33 and 34 are diagrams illustrating examples of configurations when a coherent transceiver of phase modulation is used for a user device. In this configuration, as illustrated in FIG. 33, using the user signal as a phase modulation signal, applying the AMCC signal using an external intensity modulator, and using a receiver for intensity modulation on the reception side are conceivable (see NON PATENT LITERATURE 2). At this time, it is assumed that a semiconductor optical amplifier (SOA) or the like is used as the external intensity modulator.

Alternatively, as illustrated in FIG. 34, the IQ modulator simultaneously modulates a phase and intensity, a user signal is used as a phase modulation signal, and an AMCC signal is transmitted as an intensity modulation signal similarly as described above. In this case, a configuration in which a digital signal processing circuit unit of a coherent receiver may demodulate the user signal and the AMCC signal is considered.

Further, as illustrated in FIG. 35, a configuration in which frequency modulation is applied by utilizing a frequency chirp accompanying bias current modulation of a direct modulation diode is considered (NON PATENT LITERATURE 3). In this case, the AMCC signal is superimposed on the intensity modulation component accompanying the bias current modulation in addition to the frequency modulation component. Therefore, both the coherent receiver and the intensity modulation reception optical receiver can demodulate the AMCC signal component.

### CITATION LIST

### Non Patent Literature

NON PATENT LITERATURE 1: Y. Tanaka, T. Kanai, K. Hara, M. Chen, K. Honda, T. Shindo, Y. Senoo, S. Kaneko, H. Nakamura, J. Kani, K. Sano, and T. Yoshida, “High-power-budget End-to-end Optical Connection with AMCC Superposition of SOA-integrated EA-DFB Transmitter in All-Photonics Network,” in 26th Optoelectronics and Communications Conference, P. Alexander Wai, H. Tam, and C. Yu, eds., OSA Technical Digest (Optical Society of America, 2021), paper M4A. 7.
NON PATENT LITERATURE 2: R. Igarashi, R. Koma, K. Hara, K. Honda, J.-i. Kani and T. Yoshida, “Simultaneous Reception of ASK-based AMCC Signals and QPSK Signals with Single Coherent Receiver,” 2021 Optical Fiber Communications Conference and Exhibition (OFC), 2021, pp. 1 to 3.
NON PATENT LITERATURE 3: M. Fujiwara et al., “Performance Evaluation of CPFSK Transmitters for TDM-Based Digital Coherent PON Upstream,” in Proc. OFC2017, ThlK. 5, Los Angeles, USA, 2017.

### SUMMARY OF INVENTION

### Technical Problem

In this way, there is a background that there are various methods in a modulation scheme for an AMCC signal.

In view of the foregoing circumstances, an object of the present invention is to provide a technique compatible with a modulation scheme of an AMCC signal of a communication destination.

### Solution to Problem

According to an aspect of the present invention, a transmitter includes: a first modulation unit configured to perform intensity modulation on a control signal for performing management control of communication; a second modulation unit configured to perform phase modulation or frequency modulation on the control signal; a reception modulation scheme acquisition unit configured to acquire a modulation scheme receivable by a receiver receiving the control signal; and a modulation control unit configured to cause the first or second modulation unit to modulate the control signal in accordance with a modulation scheme acquired by the reception modulation scheme acquisition unit.

According to another aspect of the present invention, a receiver includes: a reception unit configured to receive a control signal for performing management control of communication; a first demodulation unit configured to demodulate an intensity-modulated signal; a second demodulation unit configured to demodulate a phase-modulated or frequency-modulated signal; a duplication unit configured to duplicate the control signal received by the reception unit and output the control signal to the first and second demodulation units; a transmission modulation scheme acquisition unit configured to acquire a modulation scheme by which the control signal is modulated by a transmitter transmitting the control signal; and a demodulation control unit configured to cause the first or second demodulation unit to demodulate the control signal in accordance with the modulation scheme acquired by the transmission modulation scheme acquisition unit.

According to still another aspect of the present invention, a receiver includes: a reception unit configured to receive a control signal for performing management control of communication; a first demodulation unit configured to demodulate an intensity-modulated signal; a second demodulation unit configured to demodulate a phase-modulated or frequency-modulated signal; and a signal detection unit configured to detect a modulation scheme of the control signal received by the reception unit and cause the first or second demodulation unit to demodulate the control signal in accordance with the detected modulation scheme.

According to still another aspect of the present invention, a control method for a transmitter transmitting a control signal for performing management control of communication includes: a reception modulation scheme acquisition step of acquiring a modulation scheme receivable by a receiver receiving the control signal; and a modulation control step of performing intensity modulation, phase modulation, or frequency modulation on the control signal in accordance with the modulation scheme acquired in the reception modulation scheme acquisition step.

According to still another aspect of the present invention, a control method for a receiver receiving a control signal for performing management control of communication includes: a transmission modulation scheme acquisition step of acquiring a modulation scheme by which the control signal is modulated by a transmitter transmitting the control signal; and a modulation control step of demodulating the control signal as an intensity-modulated signal, as a phase-modulated signal, or as a frequency-modulated signal in accordance with the modulation scheme acquired in the transmission modulation scheme acquisition step.

### Advantageous Effects of Invention

According to the present invention, it is possible to achieve compatibility with a modulation scheme of an AMCC signal of a communication destination.

### BRIEF DESCRIPTION OF DRAWINGS

FIG. 1 is a diagram illustrating a communication system using CPFSK.

FIG. 2 is a diagram illustrating a first configuration example of a transmission device.

FIG. 3 is a diagram illustrating an example of a modulation scheme A.

FIG. 4 is a diagram illustrating an example of the modulation scheme A.

FIG. 5 is a diagram illustrating an example of a modulation scheme AB.

FIG. 6 is a diagram illustrating an example of the modulation scheme AB.

FIG. 7 is a diagram illustrating an example of a modulation scheme B.

FIG. 8 is a diagram illustrating an example of the modulation scheme B.

FIG. 9 is a flowchart illustrating a flow of processing in a first configuration example of a transmission device.

FIG. 10 is a diagram illustrating an example in point-to-multipoint communication.

FIG. 11 is a diagram illustrating a second configuration example of the transmission device.

FIG. 12 is a diagram illustrating an example of the modulation scheme A.

FIG. 13 is a diagram illustrating an example of the modulation scheme AB.

FIG. 14 is a diagram illustrating an example of the modulation scheme B.

FIG. 15 is a diagram illustrating an example of an amplification bandwidth of an SOA.

FIG. 16 is a diagram illustrating an example of the modulation scheme A.

FIG. 17 is a diagram illustrating an example of the modulation scheme AB.

FIG. 18 is a diagram illustrating an example of the modulation scheme B.

FIG. 19 is a diagram illustrating an example in point-to-multipoint communication.

FIG. 20 is a diagram illustrating a configuration example of a user device including a transmission device.

FIG. 21 is a diagram illustrating a configuration example of the user device including the transmission device.

FIG. 22 is a diagram illustrating a configuration example of a reception device.

FIG. 23 is a diagram illustrating a configuration example a reception-side DSP.

FIG. 24 is a diagram illustrating a configuration example a reception-side DSP.

FIG. 25 is a flowchart illustrating a flow of processing in a second configuration example of the reception-side DSP.

FIG. 26 is a diagram illustrating a configuration example of a reception-side DSP.

FIG. 27 is a flowchart illustrating a flow of processing in a third configuration example of the reception-side DSP.

FIG. 28 is a diagram illustrating processing in initial connection.

FIG. 29 is a sequence diagram in the initial connection.

FIG. 30 is a diagram illustrating a configuration of the IOWN.

FIG. 31 is a diagram illustrating use of a signal in which a user signal DATA and an AMCC signal DATA_AMCC are superimposed.

FIG. 32 is a diagram illustrating superimposition of the AMCC signal on a low frequency side.

FIG. 33 is a diagram illustrating a configuration example in a case where a coherent transceiver of phase modulation is used in a user device.

FIG. 34 is a diagram illustrating a configuration example in a case where a coherent transceiver of phase modulation is used in a user device.

FIG. 35 is a diagram illustrating a configuration in which frequency modulation is applied using a frequency chirp.

### DESCRIPTION OF EMBODIMENTS

An embodiment of the present invention will be described in detail with reference to the diagrams.

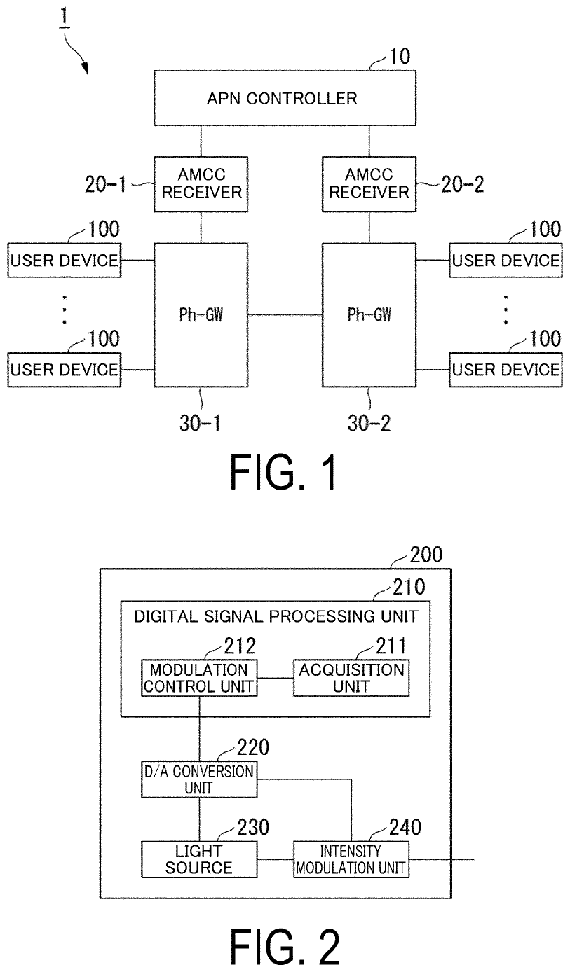

FIG. 1 is a diagram illustrating a configuration of a communication system 1 using a continuous phase FSK (CPFSK) The communication system 1 includes an all-photonics network (APN) controller 10, AMCC receivers 20-1 and 20-2, Ph-GWs 30-1 and 30-2, and user devices 100. When the AMCC receivers 20-1 and 20-2 are not particularly distinguished from each other, the AMCC receivers 20-1 and 20-2 are expressed as the AMCC receiver 20. When the Ph-GWs 30-1 and 30-2 are not distinguished from each other, the Ph-GWs 30-1 and 30-2 are expressed as the Ph-GWs 30. “Ph-GW” is an abbreviation of for a photonic GW.

The user device 100 is connected to the Ph-GW 30. The Ph-GW 30 is connected to the AMCC receiver 20. The AMCC receiver 20 is connected to the APN controller 10. In the configuration illustrated in FIG. 1, the user device 100 exchanges a control signal for managing and controlling communication with the APN controller 10 by using an auxiliary management and control channel (AMCC) in communication start, so that a wavelength or the like used for communication is set. At this time, the Ph-GW 30 sets a route to the APN controller 10 for enabling the user device 100 to perform communication.

The APN controller 10 and the Ph-GW 30 mainly have five functions. The first function is a wavelength control/monitoring function of specifying and controlling which wavelength is used by the user device 100 and monitoring the wavelength of the signal. The second function is a passing/stopping function for passing a signal in accordance with the opening of the path and stopping an unnecessary signal. The third function is a function of collecting optical signals with wavelengths set in user devices and transferring the optical signals to a relay network, and a collecting/distributing function of distributing the optical signals transferred from the relay network for each wavelength. The fourth function is a returning function of enabling returning at the Ph-GW 30 to which an optical signal is input without passing through an optical switch included in the Ph-GW 30 with respect to traffic requiring a shortest route. The fifth function is an extraction and insertion function of enabling processing at a position of the Ph-GW 30 in order to perform reproduction, relay, and electrical processing.

In such a communication system 1, the user device 100 can transmit and receive control signals to and from the user device 100 by using AMCC, not only to and from the APN controller 10 as described above. Hereinafter, for the user device 100, a configuration example of the user device 100 serving as a transmission device (transmitter) and a configuration example of the user device 100 serving as a reception device (receiver) will be described. In the following description, a control signal for managing and controlling communication using an AMCC may be expressed as an AMCC signal.

### First Configuration Example of Transmission Device

FIG. 2 is a diagram illustrating a first configuration example of a transmission device. The transmission device 200 in the first configuration example includes a digital signal processing unit 210, a DA conversion unit 220, a light source 230, and an intensity modulation unit 240. The digital signal processing unit 210 includes an acquisition unit 211 and a modulation control unit 212.

The light source 230 generates a frequency-modulated signal by a bias applied by the DA conversion unit 220. The light source 230 is, for example, a distributed feedback (DFB) laser. The frequency-modulated signal is generated by modulating a bias of the light source 230 to cause the oscillation frequency and phase transition of a laser called a chirp. Accordingly, the light source 230 can perform phase modulation or frequency modulation. In the following description, the phase modulation or the frequency modulation is expressed as “phase/frequency modulation”.

With the modulation of the bias of the light source 230, not only the frequency modulation but also an intensity modulation component are applied. Accordingly, an output signal of the light source 230 is subjected to phase and frequency transition and a change in output intensity in accordance with the bias modulation. The light source 230 is an example of a second modulation unit.

The intensity modulation unit 240 is provided at a rear stage of the light source 230. The intensity modulation unit 240 performs intensity modulation on an optical signal output from the light source 230 by the bias applied by the DA conversion unit 220. The intensity modulation unit 240 is, for example, an electro-absorption modulator (EA modulator) or a Mach-Zehnder modulator. The intensity modulation unit 240 is an example of a first modulation unit.

The digital signal processing unit 210 performs signal processing on information to be transmitted. The information to be transmitted includes user data and data to be transmitted as an AMCC signal. The acquisition unit 211 acquires a modulation scheme receivable by a reception device that receives an AMCC signal. In the embodiment, as modulation schemes which can be received by the reception device, an intensity modulation scheme, a modulation scheme for modulating both intensity modulation and phase/frequency modulation, and a phase/frequency modulation scheme are set. In the following description, the intensity modulation scheme is expressed as a “scheme A” in some cases. The phase/frequency modulation scheme is expressed as a “scheme B” in some cases. A modulation scheme of modulating both intensity modulation and phase/frequency modulation is expressed as a “scheme AB” in some cases.

As an acquisition method by the acquisition unit 211, there is a method in which a modulation scheme receivable by the reception device is stored in a storage unit provided in advance in the transmission device 200, and the modulation scheme is acquired from the storage unit. As the acquisition method, there is a method of acquiring information based on information acquired from an external communication route different from the communication system 1. The acquisition unit 211 is an example of a reception modulation scheme acquisition unit.

The modulation control unit 212 causes the light source 230 or the intensity modulation unit 240 to modulate the AMCC signal by controlling the DA conversion unit 220 in accordance with the modulation scheme acquired by the acquisition unit 211. In the following description, applying a bias for transmitting a main signal may be simply expressed as “applying the main signal”. Also, applying a bias to transmit an AMCC signal may be simply expressed as “applying the AMCC signal”.

Hereinafter, each example of each modulation scheme will be described.

### Example of Modulation Scheme A in First Configuration Example of Transmission Device

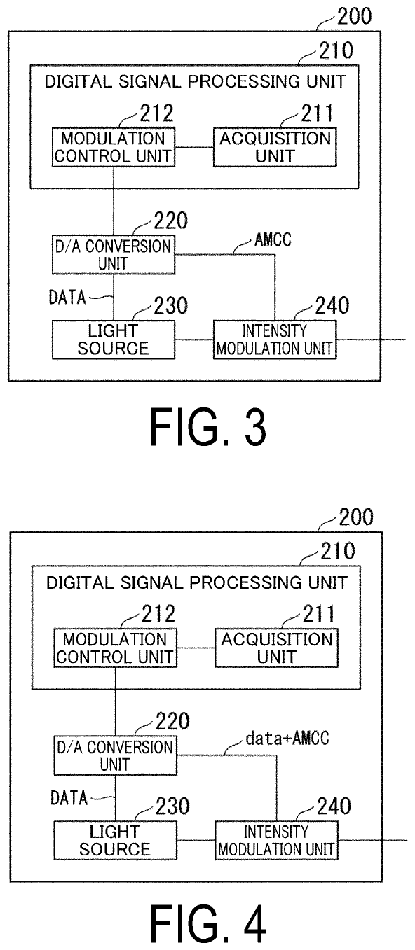

An example of a case where the acquisition unit 211 acquires the fact that the modulation scheme receivable by the reception device is the modulation scheme A will be described. FIGS. 3 and 4 are diagrams illustrating the examples in the modulation scheme A. In FIG. 3, “DATA” represents a main signal. “AMCC” represents an AMCC signal. In the drawings to be described below, “DATA” represents a main signal, and “AMCC” indicates an AMCC signal.

In FIG. 3, the modulation control unit 212 causes the light source 230 to modulate the main signal DATA by applying a main signal DATA to the light source 230. The modulation control unit 212 causes the intensity modulation unit 240 to modulate an AMCC signal by applying the AMCC signal to the intensity modulation unit 240. Accordingly, since a signal output from the light source 230 does not cause frequency transition according to the AMCC signal, only a reception device capable of receiving an AMCC signal for intensity modulation can receive the AMCC signal.

FIG. 4 is a diagram illustrating an example of a case where a pattern for canceling a modulation component by the light source 230 is applied. In FIG. 4, “data” represents a signal for canceling the main signal DATA. In the drawings to be described below, “data” represents a signal for canceling the main signal DATA.

In FIG. 4, the modulation control unit 212 causes the light source 230 to modulate the main signal DATA by applying the main signal DATA to the light source 230. The modulation control unit 212 causes the intensity modulation unit 240 to modulate the AMCC signal and a cancellation signal data by applying the AMCC signal and the cancellation signal data to the intensity modulation unit 240. Accordingly, an intensity modulation component of the main signal DATA may be removed.

### Example in Modulation Scheme AB in First Configuration Example of Transmission Device

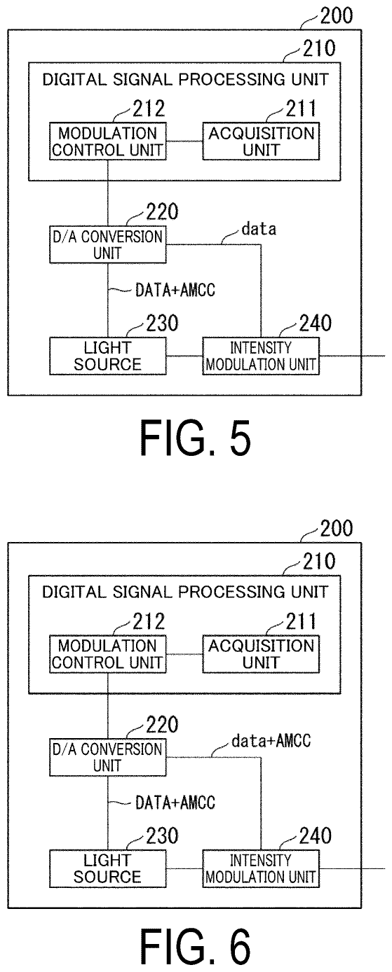

An example of a case where the acquisition unit 211 acquires the fact that the modulation scheme receivable by the reception device is the modulation scheme AB will be described. FIGS. 5 and 6 are diagrams illustrating examples in the modulation scheme AB. In FIG. 5, the modulation control unit 212 causes the light source 230 to modulate the main signal DATA and the AMCC signal by applying the main signal DATA and the AMCC signal to the light source 230. The modulation control unit 212 causes the intensity modulation unit 240 to modulate the cancellation signal data by applying the cancellation signal data to the intensity modulation unit 240. Accordingly, the intensity modulation component of the main signal DATA may be removed.

FIG. 6 is a diagram illustrating an example in which the degree of modulation of the intensity modulation of the AMCC signal is improved. When a signal is applied by CPFSK modulation, the amplitude of the signal applied to the light source 230 is very small since the signal is inhibited to a minimum frequency shift. Accordingly, an amplitude of an intensity modulation component of the AMCC signal may be insufficient for reception.

In FIG. 6, the modulation control unit 212 causes the light source 230 to modulate the main signal DATA and the AMCC signal by applying the main signal DATA and the AMCC signal to the light source 230. The modulation control unit 212 causes the intensity modulation unit 240 to modulate the cancellation signal data and the AMCC signal by applying the cancellation signal data and the AMCC signal to the intensity modulation unit 240. Accordingly, the intensity modulation unit 240 can modulate the AMCC signal in the same pattern as the AMCC signal modulated by the light source 230 to obtain the desired degree of modulation.

### Example of Modulation Scheme B in First Configuration Example of Transmission Device

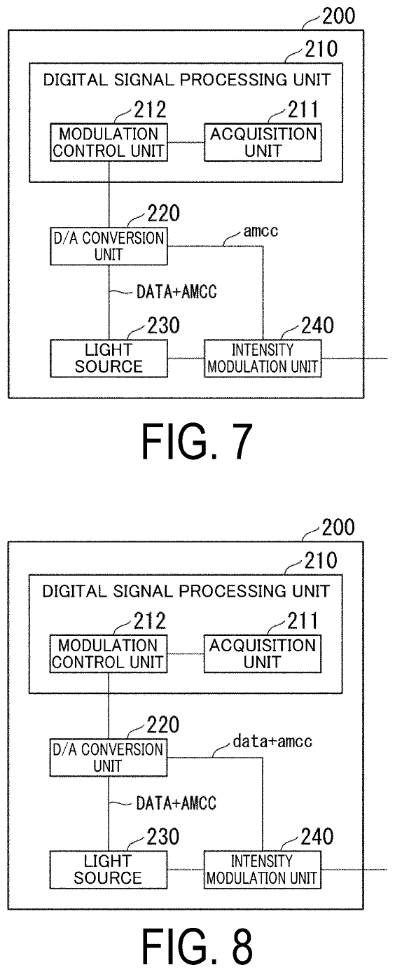

An example of a case where the acquisition unit 211 acquires the fact that the modulation scheme receivable by the reception device is the modulation scheme B will be described. FIGS. 7 and 8 are diagrams illustrating examples in the modulation scheme B. In FIG. 7, “amcc” represents a signal for canceling the AMCC signal. In the drawings to be described below, “amcc” represents a signal for canceling the AMCC signal.

In FIG. 7, the modulation control unit 212 causes the light source 230 to modulate the main signal DATA and the AMCC signal by applying the main signal DATA and an AMCC signal to the light source 230. The modulation control unit 212 causes the intensity modulation unit 240 to modulate the cancellation signal amcc by applying the cancellation signal amcc to the intensity modulation unit 240. Accordingly, an intensity modulation component of the AMCC signal may be removed.

FIG. 8 is a diagram illustrating an example in which reception sensitivity of the main signal DATA in the reception device is improved. In FIG. 8, the modulation control unit 212 causes the light source 230 to modulate the main signal DATA and the AMCC signal by applying the main signal DATA and the AMCC signal to the light source 230. The modulation control unit 212 causes the intensity modulation unit 240 to modulate the cancellation signal data and the cancellation signal amcc by applying the cancellation signal data and the cancellation signal amcc to the intensity modulation unit 240. Accordingly, an intensity modulation component of the main signal DATA may be removed.

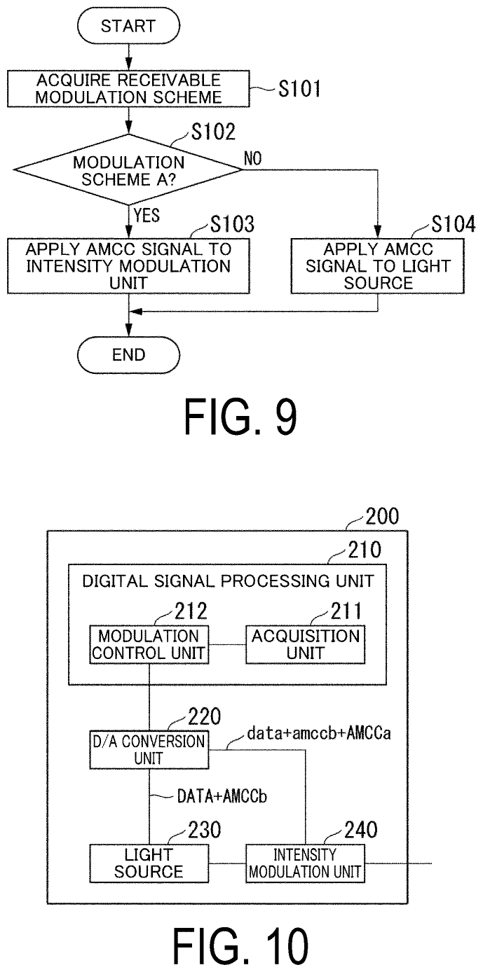

Next, a flow of processing in the first configuration example of the transmission device will be described. FIG. 9 is a flowchart illustrating a flow of processing in the first configuration example of the transmission device. In FIG. 9, the acquisition unit 211 acquires a receivable modulation scheme (step S101). The modulation control unit 212 is notified of the acquired modulation scheme. The modulation control unit 212 determines whether the acquired modulation scheme is the modulation scheme A (S102). When the acquired modulation scheme is the modulation scheme A, the modulation control unit 212 applies the AMCC signal to the intensity modulation unit 240 by controlling the DA conversion unit 220 (step S103). Conversely, when the acquired modulation scheme is not the modulation scheme A, the acquired modulation scheme is a modulation scheme AB or the modulation scheme B. Accordingly, the modulation control unit 212 applies the AMCC signal to the light source 230 by controlling the DA conversion unit 220 (step S104).

### Example Corresponding to Modulation Scheme A and Modulation Scheme B in First Configuration Example of Transmission Device

In the first configuration example of the transmission device, an example of the time of point-to-multipoint communication will be described. It is assumed that the transmission device communicates with the reception devices a and b. It is assumed that the reception device a can perform reception in accordance with the modulation scheme A and the reception device b can perform reception in accordance with the modulation scheme B.

FIG. 10 is a diagram illustrating an example of the time of point-to-multipoint communication. In FIG. 7, “AMCCa” represents an AMCC signal to the reception device a. “AMCCb” represents an AMCC signal to the reception device b. “amccb” represents a signal for canceling “AMCCb”.

In FIG. 10, the modulation control unit 212 causes the light source 230 to modulate the main signal DATA and the AMCCb signal by applying the main signal DATA and the AMCCb signal to the light source 230. The modulation control unit 212 causes the intensity modulation unit 240 to modulate the cancellation signal data, the cancellation signal amccb and the AMCCa signal by applying the cancellation signal data and the cancellation signal amcc to the intensity modulation unit 240. Accordingly, an intensity component generated in direct modulation of the light source 230 is removed. The transmission of the AMCC signal to the plurality of reception devices may be performed in accordance with a time slot using a time division multiplexing scheme. Even in the first configuration example of the transmission device, communication by a subcarrier may be performed.

As described above, in the first configuration example, a technique compatible with a modulation scheme of an AMCC signal of a communication destination can be provided.

### Second Configuration Example of Transmission Device

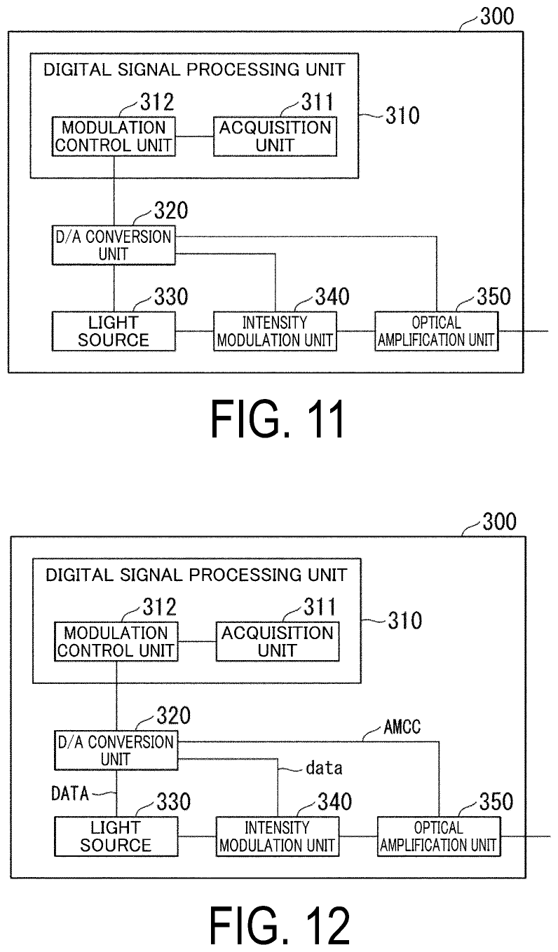

FIG. 11 is a diagram illustrating a second configuration example of the transmission device. In the second configuration example, an optical amplifier is provided at the rear stage of the intensity modulation unit in the first configuration example. The optical amplifier is, for example, a semiconductor optical amplifier (SOA). In that a modulation bandwidth of the SOA is limited to a few GHz, the second configuration example can be implemented only when a main signal rate is equal to or less than the SOA modulation bandwidth.

A transmission device 300 in the second configuration example includes a digital signal processing unit 310, a DA conversion unit 320, a light source 330, an intensity modulation unit 340, and an optical amplification unit 350. The digital signal processing unit 310 includes an acquisition unit 311 and a modulation control unit 312.

The light source 330 generates a frequency-modulated signal by the bias applied by the DA conversion unit 320. The light source 330 is, for example, a DFB (Distributed fed back) laser. The frequency-modulated signal is generated by modulating the bias of the light source 330 to cause the oscillation frequency and phase transition of a laser called a chirp. Accordingly, the light source 330 can perform phase modulation or frequency modulation.

With the modulation of the bias of the light source 330, not only the frequency modulation but also the intensity modulation component is applied. Therefore, an output signal of the light source 330 is subjected to phase and frequency transition and a change in output intensity in accordance with the bias modulation. The light source 330 is an example of a second modulation unit.

The intensity modulation unit 340 is provided at a rear stage of the light source 330. An intensity modulation unit 340 performs intensity modulation on the optical signal output from the light source 330 by the bias applied by the DA conversion unit 320. The intensity modulation unit 340 is, for example, an electro-absorption modulator (EA modulator) or a Mach-Zehnder modulator. The intensity modulation unit 340 is an example of a first modulation unit.

The optical amplifier 360 amplifies an optical signal modulated by the intensity modulation unit 340. The optical amplifier 360 superimposes or cancels the AMCC signal on the optical signal intensity-modulated by the bias applied by the DA conversion unit 320.

The digital signal processing unit 310 performs signal processing on information to be transmitted. The information to be transmitted includes user data and data to be transmitted as an AMCC signal. The acquisition unit 311 acquires a modulation scheme receivable by a reception device that receives the AMCC signal.

As an acquisition method by the acquisition unit 311, there is a method in which a modulation scheme receivable by the reception device is stored in a storage unit provided in advance in the transmission device 300, and the modulation scheme is acquired from the storage unit. As an acquisition method, there is a method of acquiring information based on information acquired from an external communication route different from the communication system 1. The acquisition unit 311 is an example of a reception modulation scheme acquisition unit.

The modulation control unit 312 causes the light source 330 or the optical amplification unit 350 to modulate the AMCC signal by controlling the DA conversion unit 320 in accordance with the modulation scheme acquired by the acquisition unit 311.

### Example of Modulation Scheme A in Second Configuration Example of Transmission Device

An embodiment in which the acquisition unit 211 acquires that the modulation scheme receivable by the reception device is the modulation scheme A is shown. FIG. 12 is a diagram of an example in the modulation scheme A.

In FIG. 12, the modulation control unit 212 causes the light source 230 to modulate the main signal DATA by applying a main signal DATA to the light source 230. The modulation control unit 212 causes the intensity modulation unit 240 to modulate the cancellation signal data by applying the cancellation signal data to the intensity modulation unit 240. The modulation control unit 212 superimposes the AMCC signal on an optical signal output from the intensity modulation unit 340 by applying the AMCC signal to the optical amplification unit 350.

### Example in Modulation Scheme AB in Second Configuration Example of Transmission Device

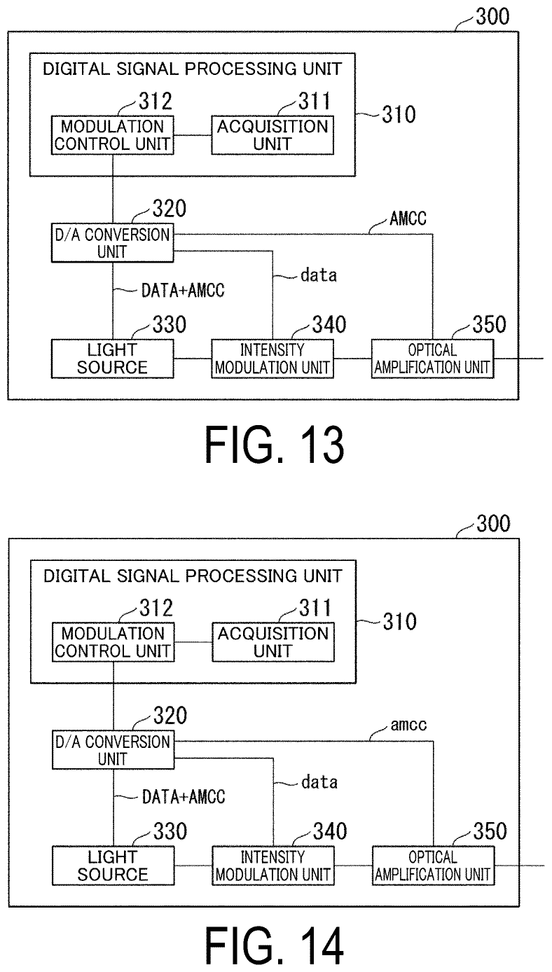

An example of a case where the acquisition unit 211 acquires the fact that the modulation scheme receivable by the reception device is the modulation scheme AB will be described. FIG. 13 is a diagram illustrating an example in the modulation scheme AB.

In FIG. 13, the modulation control unit 212 causes the light source 230 to modulate the main signal DATA and the AMCC signal by applying the main signal DATA and the AMCC signal to the light source 230. The modulation control unit 212 causes the intensity modulation unit 240 to modulate the cancellation signal data by applying the cancellation signal data to the intensity modulation unit 240. The modulation control unit 212 superimposes the AMCC on the optical signal output from the intensity modulation unit 340 by applying the AMCC signal to the optical amplification unit 350.

### Example of Modulation Scheme B in Second Configuration Example of Transmission Device

An example of a case where the acquisition unit 211 acquires the fact that the modulation scheme receivable by the reception device is the modulation scheme B will be described. FIG. 14 is a diagram illustrating an example in the modulation scheme B.

In FIG. 14, the modulation control unit 212 causes the light source 230 to modulate the main signal DATA and the AMCC signal by applying the main signal DATA and an AMCC signal to the light source 230. The modulation control unit 212 causes the intensity modulation unit 240 to modulate the cancellation signal data by applying the cancellation signal data to the intensity modulation unit 240. The modulation control unit 212 superimposes the cancellation signal amcc on the optical signal output from the intensity modulation unit 340 by applying the cancellation signal amcc to the optical amplification unit 350.

As described above, in the second configuration example, it is possible to provide a technique compatible with the modulation scheme of the AMCC signal of a communication destination.

### Example in which Amplification Bandwidth is Used in Second Configuration Example of Transmission Device

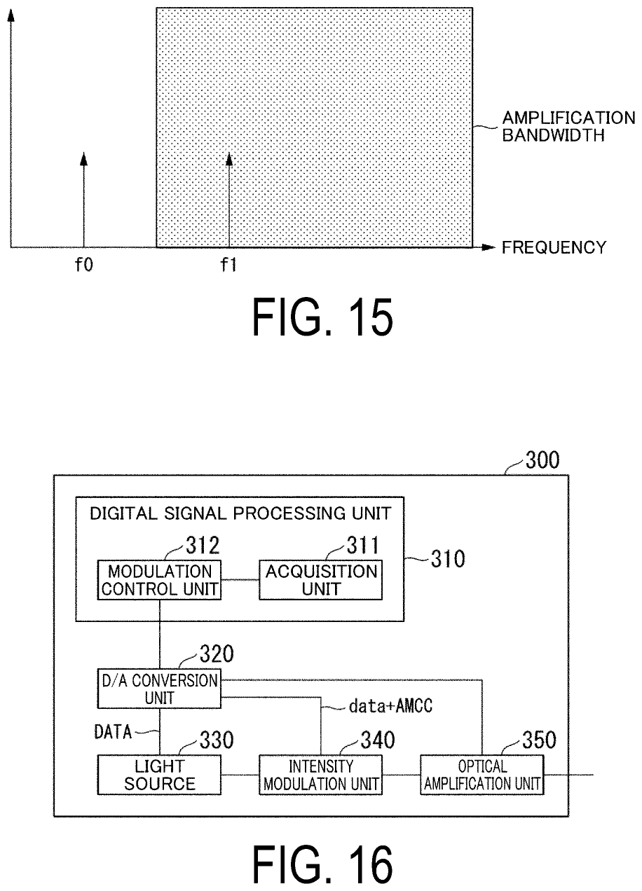

Next, an example in which an amplification bandwidth of the optical amplifier provided at the rear stage of the intensity modulation unit 340 is used will be described. FIG. 15 is a diagram illustrating an example of the amplification bandwidth of the SOA. In FIG. 15, a frequency f0 is not included in the amplification bandwidth, and a frequency f1 is included in the amplification bandwidth. The SOA has characteristics that an intensity modulation signal component in a low frequency region such as the frequency f1 is not transmitted. Accordingly, an example in which an AMCC signal superimposed on a subcarrier is transmitted will be described.

### Example in Modulation Scheme A in which Amplification Bandwidth is Used in Second Configuration Example of Transmission Device

An example in which the acquisition unit 211 acquires the fact that the modulation scheme receivable by the reception device is the modulation scheme A will be described. FIG. 16 is a diagram illustrating an example in the modulation scheme A.

In FIG. 16, the modulation control unit 212 causes the light source 230 to modulate the main signal DATA by applying the main signal DATA to the light source 230. The modulation control unit 212 causes the intensity modulation unit 240 to modulate the cancellation signal data and the AMCC signal by applying the cancellation signal data and the AMCC signal to the intensity modulation unit 240. At this time, the intensity modulation unit 240 superimposes the AMCC signal at the frequency f1 within the SOA amplification bandwidth.

### Example in Modulation Scheme AB in which Amplification Bandwidth is Used in Second Configuration Example of Transmission Device

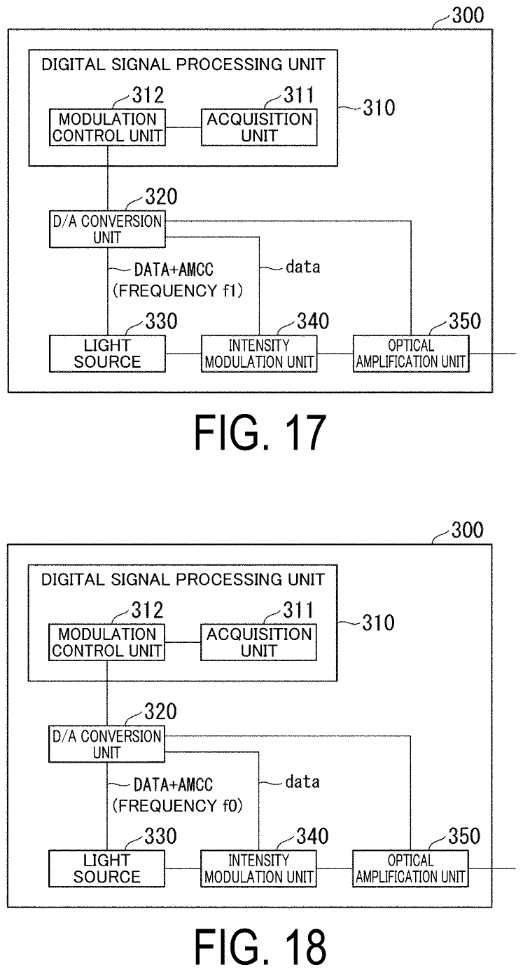

An example of a case where the acquisition unit 211 acquires the fact that the modulation scheme receivable by the reception device is the modulation scheme AB will be described. FIG. 17 is a diagram illustrating an example in the modulation scheme AB.

In FIG. 17, the modulation control unit 212 causes the light source 230 to modulate the main signal DATA and the AMCC signal by applying the main signal DATA and an AMCC signal to the light source 230. At this time, the light source 230 superimposes the AMCC signal at the frequency f1 within the SOA amplification bandwidth. The modulation control unit 212 causes the intensity modulation unit 240 to modulate the cancellation signal data by applying the cancellation signal data to the intensity modulation unit 240.

### Example in Modulation Scheme B in which Amplification Bandwidth is Used in Second Configuration Example of Transmission Device

An example in which the acquisition unit 211 acquires the fact that the modulation scheme receivable by the reception device is the modulation scheme B will be described. FIG. 18 is a diagram illustrating an example in the modulation scheme B.

In FIG. 18, the modulation control unit 212 causes the light source 230 to modulate the main signal DATA and the AMCC signal by applying the main signal DATA and the AMCC signal to the light source 230. At this time, the light source 230 superimposes the AMCC signal at the frequency f0 outside of the SOA amplification bandwidth. The modulation control unit 212 causes the intensity modulation unit 240 to modulate the cancellation signal data by applying the cancellation signal data to the intensity modulation unit 240. Accordingly, the AMCC signal superimposed on the intensity modulation component is removed. However, since the AMCC signal superimposed on transition of a wavelength caused by a frequency chirp remains, transmission can be performed by the modulation scheme B.

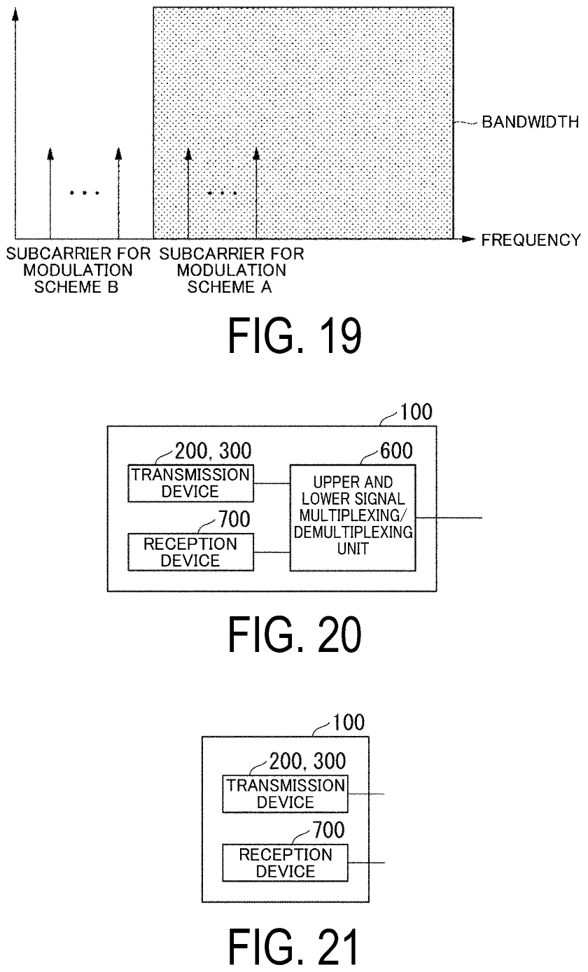

FIG. 19 is a diagram illustrating an example in point-to-multipoint communication. As illustrated in FIG. 19, communication is performed using a bandwidth outside of the amplification bandwidth of the SOA as a subcarrier for the modulation scheme B and using the modulation scheme in the amplification bandwidth of the SOA as a subcarrier for the modulation scheme A. The subcarriers may be shared in combination with a time division multiplexing scheme.

As described above, in the second configuration example, it is possible to provide a technique compatible with the modulation scheme of the AMCC signal of the communication destination by using the amplification bandwidth.

### Configuration Example of User Device

FIGS. 20 and 21 are diagrams illustrating examples of the configuration of the user device 100 including the above-described transmission devices (transmitter) 200 and 300. The user device 100 in FIG. 20 includes the transmission device 200 or 300, a reception device (receiver) 700, and an upper and lower signal multiplexer/demultiplexer 600. The user device 100 in FIG. 21 includes the transmission device 200 or 300 and the reception device 700.

As illustrated in FIG. 20, the user device 100 according to the embodiment may be of a single-core bidirectional type having an upper and lower multiplexing/demultiplexing unit or may be of a double-core type multiplexing/demultiplexing unit in which transmitted and received signals are input and output through separate ports, as illustrated in FIG. 21.

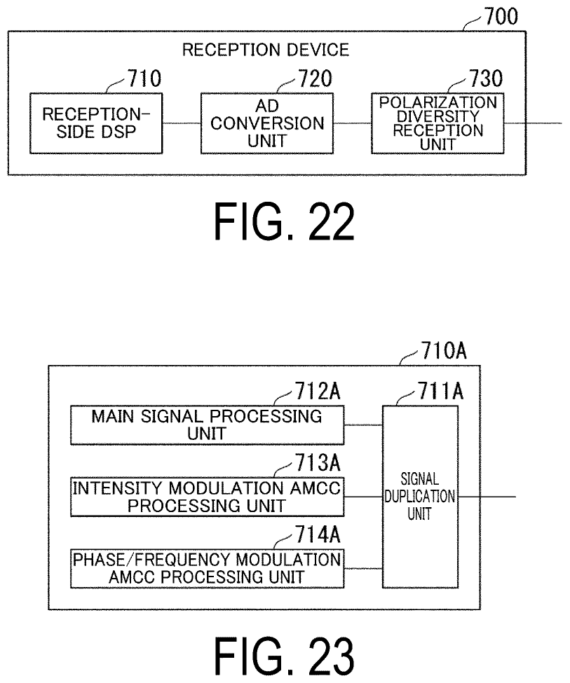

FIG. 22 is a diagram illustrating a configuration example of the reception device 700 according to the embodiment. The reception device 700 includes a reception-side DSP 710, an AD conversion unit 720, and a polarization diversity reception unit 730. The AD conversion unit 720 is provided at the rear stage of the polarization diversity reception unit 730, and the reception-side DSP 710 is provided at the rear stage of the AD conversion unit 720.

The polarization diversity reception unit 730 performs intra-dyne detection. The signal photoelectrically converted by the polarization diversity receiver is converted into a digital signal by the AD conversion unit 720. The reception-side DSP demodulates the main signal and the AMCC signal from a digital signal input from the AD conversion unit 720.

### Configuration Example of Reception-Side DSP

Hereinafter, a configuration example of the three types of reception-side DSPs 710 (710A, 710B, and 710C) will be described below.

### First Configuration Example of Reception-Side DSP

FIG. 23 is a diagram illustrating a configuration example of the reception-side DSP 710A. The reception-side DSP 710A includes a signal duplication unit 711A, a main signal processing unit 712A, an intensity modulation AMCC processing unit 713A, and a phase/frequency modulation AMCC processing unit 714A. The signal duplication unit 711A duplicates the signal input from the AD conversion unit 720 and outputs the duplicated signal to the main signal processing unit 712A, the intensity modulation AMCC processing unit 713A, and the phase/frequency modulation AMCC processing unit 714A.

The main signal processing unit 712A demodulates the main signal. The intensity modulation AMCC processing unit 713A demodulates the intensity-modulated AMCC signal. The phase/frequency modulation AMCC processing unit 714A demodulates the phase/frequency-modulated AMCC signal. For the intensity-modulated AMCC signal, for example, as described in NON PATENT LITERATURE 2, a scheme of demodulating the AMCC signal after the AMCC signal is separated from the main signal may be used.

### Second Configuration Example of Reception-Side DSP

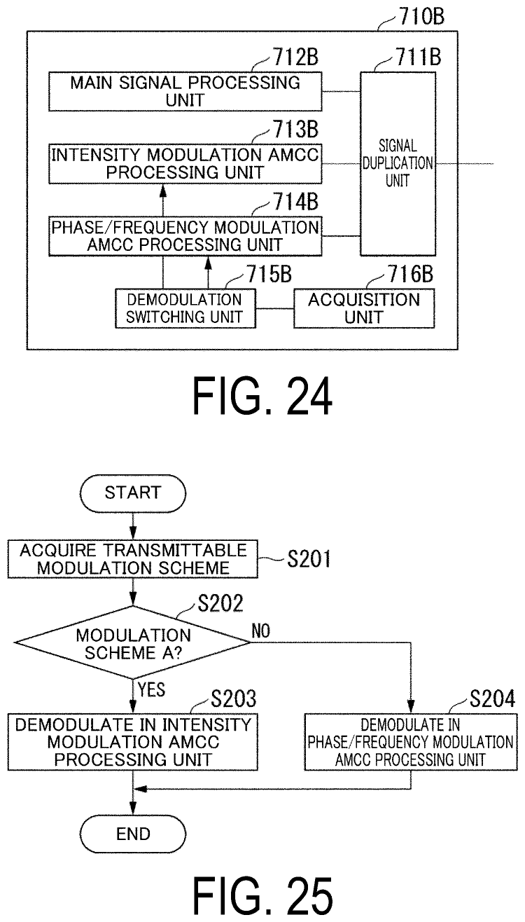

FIG. 24 is a diagram illustrating a configuration example of the reception-side DSP 710B. The reception-side DSP 710B includes a signal duplication unit 711B, a main signal processing unit 712B, an intensity modulation AMCC processing unit 713B, a phase/frequency modulation AMCC processing unit 714B, a demodulation switching unit 715B, and an acquisition unit 716B. The signal duplication unit 711B duplicates a signal input from the AD conversion unit 720 and outputs the duplicated signal to the main signal processing unit 712B, the intensity modulation AMCC processing unit 713B, and the phase/frequency modulation AMCC processing unit 714B.

The main signal processing unit 712B demodulates the main signal. The intensity modulation AMCC processing unit 713B demodulates the intensity-modulated AMCC signal. The phase/frequency modulation AMCC processing unit 714B demodulates the phase/frequency-modulated AMCC signal.

The acquisition unit 716B acquires modulation schemes (modulation schemes A, B, and AB) which can be transmitted by a transmission device transmitting the AMCC signal. As an acquisition method by the acquisition unit 211, there is a method in which a modulation scheme that can be transmitted by the transmission device is stored in a storage unit provided in advance in the reception device 700, and the modulation scheme is acquired from the storage unit. As the acquisition method, there is a method of acquiring information based on information acquired from an external communication route different from the communication system 1. The acquired modulation scheme is output to the demodulation switching unit 715B.

When the modulation scheme output from the acquisition unit 716B is the scheme A, the demodulation switching unit 715B causes the intensity modulation AMCC processing unit 713B to demodulate the AMCC signal. When the modulation scheme output from the acquisition unit 716B is the scheme B or the scheme AB, the demodulation switching unit 715B causes the phase/frequency modulation AMCC processing unit 714B to demodulate the AMCC signal.

A flow of processing in the second configuration example of the above-described reception-side DSP described above will be described. FIG. 25 is a flowchart illustrating a flow of processing in the second configuration example of the above-described reception-side DSP. In FIG. 25, the acquisition unit 716B acquires a transmittable modulation scheme (step S201). The demodulation switching unit 715B is notified of the acquired modulation scheme. The demodulation switching unit 715B determines whether the acquired modulation scheme is the modulation scheme A (step S202). When the acquired modulation scheme is the modulation scheme A, the demodulation switching unit 715B demodulates an AMCC signal by the intensity modulation AMCC processing unit 713B (step S203). Conversely, when the acquired modulation scheme is not the modulation scheme A, the acquired modulation scheme is the modulation scheme AB or B. Then, the demodulation switching unit 715B causes the phase/frequency modulation AMCC processing unit 714B to demodulate the AMCC signal (step S204).

### Third Configuration Example of Reception-Side DSP

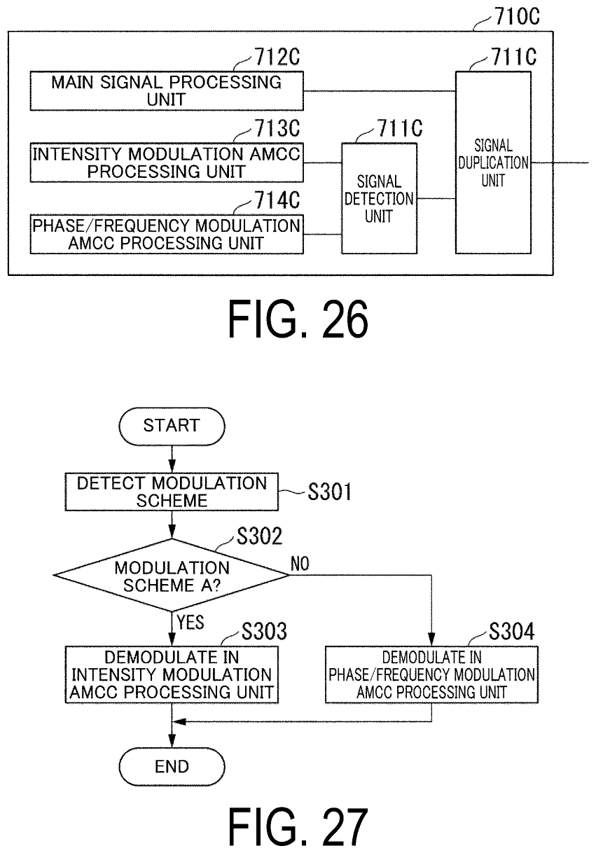

FIG. 26 is a diagram illustrating a configuration example of the reception-side DSP 710C. The reception-side DSP 710C includes a signal duplication unit 711C, a main signal processing unit 712C, an intensity modulation AMCC processing unit 713C, a phase/frequency modulation AMCC processing unit 714C, and a signal detection unit 717C. The signal duplication unit 711C duplicates the signal input from the AD conversion unit 720 and outputs the duplicated signal to the main signal processing unit 712C and the signal detection unit 717C.

The main signal processing unit 712C demodulates the main signal. The intensity modulation AMCC processing unit 713C demodulates the intensity-modulated AMCC signal. The phase/frequency modulation AMCC processing unit 714C demodulates the phase/frequency-modulated AMCC signal. The signal detection unit 717C detects whether the AMCC signal is intensity-modulated or phase/frequency-modulated from a reception signal pattern and signal intensity. The signal detection unit 717C outputs a signal to the intensity modulation AMCC processing unit 713C when the AMCC signal is intensity-modulated and detected. The signal detection unit 717C outputs a signal to the phase/frequency modulation AMCC processing unit 714C when the AMCC signal is phase/frequency-modulated and detected. In this way, the signal detection unit 717C causes the intensity modulation AMCC processing unit 713C or the phase/frequency modulation AMCC processing unit 714C to demodulate the AMCC signal in accordance with the detected modulation scheme.

A flow of processing in the third configuration example of the above-described reception-side DSP will be described. FIG. 27 is a flowchart illustrating a flow of processing in the third configuration example of the above-described reception-side DSP. In FIG. 27, the signal detection unit 717C detects whether the AMCC signal is intensity-modulated or phase/frequency-modulated (step S301). The signal detection unit 717C determines whether the detected modulation scheme is the modulation scheme A (step S302). When the detected modulation scheme is the modulation scheme A, the signal detection unit 717C outputs the signal to the intensity modulation AMCC processing unit 713C and causes the intensity modulation AMCC processing unit 713C to demodulate the AMCC signal (step S303). Conversely, when the detected modulation scheme is not the modulation scheme A, the detected modulation scheme is the modulation scheme AB or B. Accordingly, the signal detection unit 717C outputs a signal to the phase/frequency modulation AMCC processing unit 714C to demodulate the AMCC signal (step S304).

As described above, by providing a configuration for demodulating the intensity-modulated AMCC signal and a configuration for demodulating the phase/frequency-modulated AMCC signal, it is possible to provide a technique compatible with the modulation scheme of the AMCC signal of the communication destination.

### Example of Processing in Initial Connection

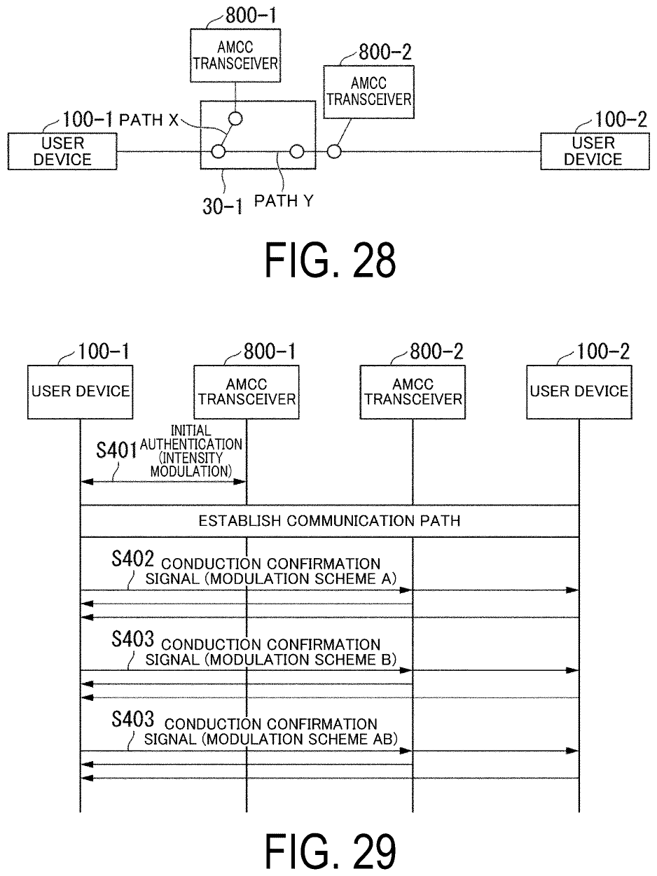

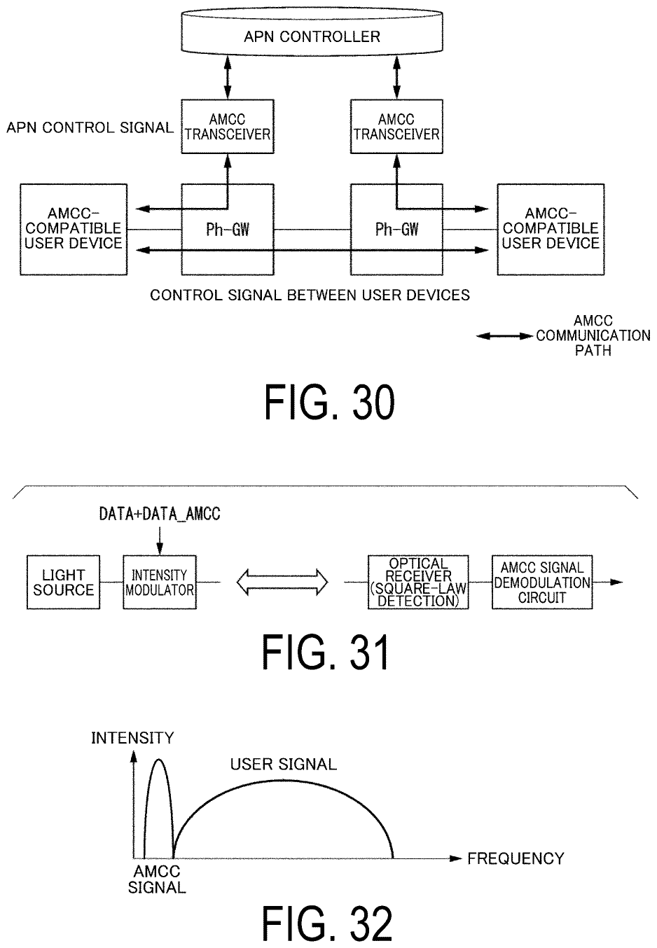

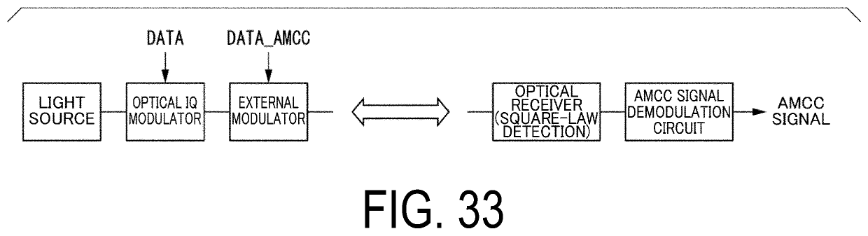

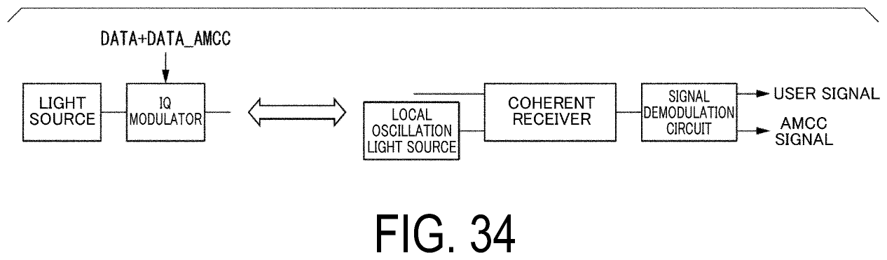

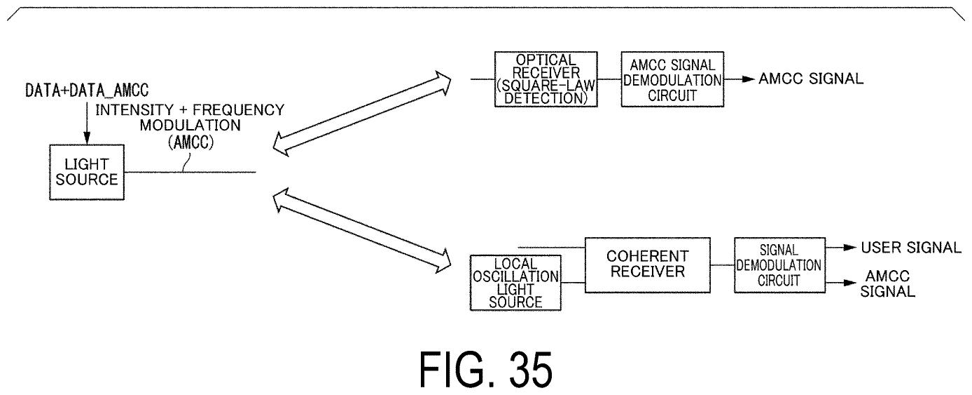

Next, an example of processing in initial connection in the user device 100 including the above-described transmission device will be described. FIG. 28 is a diagram illustrating processing in the initial connection. FIG. 28 illustrates user devices 100-1, 100-2, the Ph-GW 30-1, and AMCC transceivers 800-1 and 800-2.

In FIG. 28, it is assumed that the user device 100-1 is a transmitting side and the user device 100-2 is a reception side. The AMCC transceiver 800-1 is an AMCC transceiver 800-1 to which the user device 100-1 is connected in the initial connection. It is assumed that a transceiver of an intensity modulation-2-square detection scheme is mounted on the AMCC transceiver 800-1. The AMCC transceiver 800-2 transmits and receives an AMCC signal while the user devices 100-1 and 100-2 communicate with each other.

Based on this configuration, processing in the initial connection will be described with reference to the sequence diagram at the initial connection in FIG. 29.

In an initial state, the user device 100-1 is connected to an initial port of the Ph-GW 30-1 and connected to the AMCC transceiver 800-1 along a route X. The user device 100-1 communicates with the AMCC transceiver 800-1 with the jointly modulated AMCC signal to perform initial authentication (step S401) of the user device 100-1 and guarantees a path with the user device 100-2 (switched to a route Y: see FIG. 28). Accordingly, a communication route with the communication device 100-2 is established.

When the communication route is established, the user device 100-1 transmits a conduction confirmation signal by each modulation scheme. Each conduction confirmation signal is transmitted to the AMCC transceiver 800-2 and the user device 100-2. For example, the user device 100-1 transmits a conduction confirmation signal by the modulation scheme A (step S402), transmits a conduction confirmation signal by the modulation scheme B (step S402), and transmits a conduction confirmation signal by the modulation scheme AB (step S403).

The AMCC signal is modulated by a modulation scheme receivable by the user device 100-2 with the conduction confirmation signals. In FIG. 29, the conduction confirmation signals by all the modulation schemes are transmitted to facilitate understanding. For example, when it is proved that communication between the AMCC transceiver 800-2 and the user device 100-2 in the modulation scheme A is possible, the following conduction confirmation signals (modulation schemes B and AB) may not be transmitted. The user device 100-2 may transmit the conduction confirmation signal, or may perform conduction confirmation in the same manner even after the communication route is established. The same applies to point-to-multipoint communication as illustrated in FIGS. 10 and 19. When a time division multiplexing scheme is used, time synchronization and a delay time for collision avoidance may be given to the user device 100-1 as in an authentication phase of the PON system.

When the intensity modulation scheme is used, the AMCC signal flowing on the route can be relatively easily acquired by interrupting a simple receiver on the communication route. Therefore, when compatibility with a modulation scheme other than the intensity modulation scheme is possible, the communication may be performed in accordance with the modulation scheme other than the intensity modulation scheme. It may be more difficult to acquire the AMCC signal than when the intensity modulation scheme is used, and thus it is possible to prevent intercepting by a malicious third party.

Although the embodiment of the present invention has been described in detail with reference to the drawings, a specific configuration is not limited to the embodiment, and design and the like within the scope of the gist of the present invention are included.

### INDUSTRIAL APPLICABILITY

The present invention can be applied to a communication system using an AMCC signal.

Reference Signs List

| | |
|---|---|
| 1 | Communication system |
| 10 | APN controller |
| 100 | User device |
| 200 | Transmission device |
| 210 | Digital signal processing unit |
| 211 | Acquisition unit |
| 212 | Modulation control unit |
| 220 | Conversion unit |
| 230 | Light source |
| 240 | Intensity modulation unit |
| 300 | Transmission device |
| 310 | Digital signal processing unit |
| 311 | Acquisition unit |
| 312 | Modulation control unit |
| 320 | Conversion unit |
| 330 | Light source |
| 340 | Intensity modulation unit |
| 350 | Optical amplification unit |
| 360 | Optical amplifier |
| 600 | Demultiplexer |
| 700 | Reception device |
| 711A | Signal duplication unit |
| 711B | Signal duplication unit |
| 711C | Signal duplication unit |
| 712A | Main signal processing unit |
| 712B | Main signal processing unit |
| 712C | Main signal processing unit |
| 713A | Intensity modulation AMCC processing unit |
| 713B | Intensity modulation AMCC processing unit |
| 713C | Intensity modulation AMCC processing unit |
| 714A | Phase/frequency modulation AMCC processing unit |
| 714B | Phase/frequency modulation AMCC processing unit |
| 714C | Phase/frequency modulation AMCC processing unit |
| 715B | Demodulation switching unit |
| 716B | Acquisition unit |
| 717C | Signal detection unit |
| 720 | Conversion unit |
| 730 | Polarization diversity reception unit |
| 800-1 | Transceiver |
| 800-2 | Transceiver |

1. A transmission device comprising:
a first modulator that performs modulation on a control signal for performing management control of communication;
a second modulator that performs phase modulation or frequency modulation on the control signal;
a reception modulation scheme acquirer that acquires a modulation scheme receivable by a receiver receiving the control signal; and
a modulation controller that causes the first or second modulator to modulate the control signal in accordance with a modulation scheme acquired by the reception modulation scheme acquirer.

2. The transmission device according to claim 1, wherein, when the receiver can receive a signal subjected to the phase modulation, the frequency modulation, and the intensity modulation, the second modulator modulates the main signal and the control signal and the first modulator provided at a rear stage of the second modulator modulates a signal for canceling the main signal.

3. The transmission device according to claim 2, wherein the second modulator modulates the control signal in addition to the signal for canceling the main signal by the first modulator.

4. The transmission device according to claim 1, wherein, when the control signal is transmitted to a first receiver capable of receiving an intensity-modulated signal and the control signal is transmitted to a second receiver capable of receiving a phase-modulated or frequency-modulated signal, the second modulator modulates the main signal and the control signal for the second receiver and the first modulator provided at the rear stage of the second modulator modulation unit modulates a signal for canceling the main signal, a signal for canceling the control signal for the second receiver, and the control signal for the first receiver.

5. A receiver comprising:
a receiver that receives a control signal for performing management control of communication;
a first demodulator that demodulates an intensity-modulated signal;
a second demodulator that demodulates a phase-modulated or frequency-modulated signal;
a duplicator that duplicates the control signal received by the receiver and output the control signal to the first and second demodulators;
a transmission modulation scheme acquirer that acquires a modulation scheme by which the control signal is modulated by a transmission device transmitting the control signal; and
a demodulation controller that causes the first or second demodulator to demodulate the control signal in accordance with the modulation scheme acquired by the transmission modulation scheme acquirer.

6. A receiver comprising:
a receiver that receives a control signal for performing management control of communication;
a first demodulator that demodulates an intensity-modulated signal;
a second demodulator that demodulates a phase-modulated or frequency-modulated signal; and
a signal detector that detects a modulation scheme of the control signal received by the receiver and cause the first or second demodulator to demodulate the control signal in accordance with the detected modulation scheme.

7. (canceled)

8. (canceled)
